(19) United States
(12) Patent Application Publication
(10) Pub. No.: US 2003/0047585 A1
(43) Pub. Date: Mar. 13, 2003

(54) Welding carriage

(76) Inventors: Robert Wendell McCombe, Edmonton (CA); William Eli Marhofer, Edmonton (CA)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 09/969,508

(22) Filed: Oct. 3, 2001

(30) Foreign Application Priority Data
Sep. 7, 2001 (CA) 2,356,822

(51) Int. Cl. B23K 1/14; B23K 37/04

(52) U.S. Cl. 228/49.1

(57) ABSTRACT

A carriage is adapted to travel along a guide-band mounted about a pipe section. The carriage has a frame that includes a platform for carrying the welding apparatus. Connected to the frame are swing arms whose angular positions relative to the frame are adjustable to allow the carriage to accommodate the curvature of the pipe section. Indexing assemblies that include indexing discs and locking pins are co-operable with each swing arm and elements of the frame to allow each swing arm to be fixed in one predetermined angular position selected from a set of discrete angular positions relative to the frame. The carriage also has an arrangement of drive and idler wheel assemblies which engage opposite edges of the guide-band to effect travel of the carriage in a constrained motion about the guide-band. The wheel assemblies are arranged generally symmetrically about the carriage and are evenly distributed about the carriage. Biasing mechanisms are further provided to urge the wheel assemblies against the edges of the guide-band.

### FIELD OF THE INVENTION

The present invention relates generally to the field of automated welding, and more particularly, to a welding carriage for supporting pipe welding or weld inspection equipment.

### BACKGROUND OF THE INVENTION

Pipelines for the conveyance of oil, natural gas, water or the like are typically formed by welding adjoining sections of pipe to each other. In some instances, the welding operations are performed by an automated welding apparatus equipped with a welding torch. In such cases, it is typical for the welding apparatus to be mounted onto a movable platform in the nature of a motor-driven, welding carriage or “bug”, as it is commonly known in the industry. The welding carriage is supported on, and adapted to travel along, a track which typically runs circumferentially about the end of one of the pipe sections. The track generally consists of a flat, relatively thin, metal guide-band secured to, and offset a fixed distance from, the outer surface of one of the pipe sections to be welded. In operation, as the welding carriage travels along the track, the welding torch welds the pipe sections in a continuous fashion along a generally bevelled welding groove or joint. Multiple passes of the welding torch are usually required to fill the welding groove with weld metal to form a welded girth joint between the pipe sections.

Welding carriages tend to be used in a variety of field conditions. For instance, the diameter of the pipe sections to be welded will often vary from job to job. In particular applications, the diameter of a pipe section may be as large as 60 inches. Occasionally, however, the pipe section may have a relatively, smaller diameter for instance, 16 inches or less. Accordingly, welding carriages are typically provided with adjustable structures, such as, articulated frames to permit the carriages to generally accommodate for the variance in the curvature of the pipe section. Such articulated frames typically include three hinge-connected support plates, that is, a center support plate hingedly mounted between two end support plates. The angular position of the end support plates relative to the center support plate may be adjusted to configure the welding carriage for travel about a pipe of a particular diameter.

One welding carriage that is currently available uses an arrangement of curved slide bars movable through clamping members to adjust the angular positions of the end support plates. In this arrangement, the slide bars are fixed to the central support plate, while the clamping members are fixed to the end support plates. The clamping members may be released by loosening adjustment screws to allow movement of the slide bars through the clamping members. This allows the end support plates to be positioned to conform to the curvature of the pipe section. The adjustment screws can then be tightened to lock the clamping members in place at a particular curvature adjustment setting. In this particular arrangement, curvature adjustment of the welding carriage is performed manually by the operator of the automated welding apparatus. The operator approximates the curvature adjustment required, adjusts the angular positions of the end support plates accordingly, and then fine tunes the clamping member and slide bar arrangement until the desired curvature of the welding carriage is obtained. In this way, curvature adjustment is generally achieved through approximation and by trial and error.

The above type of arrangement generally yields acceptable results when used in relatively large diameter pipe welding operations. But, at times, it can be a time-consuming operation. Moreover, where the pipe section to be welded has a relatively tighter radius of curvature, this manner of adjustment may not be altogether suitable. This is because, in the case of a relatively small diameter pipe, a minor error in setting the angular position of the end support plates tends to result in an amplified error in the curvature of the welding carriage. If the curvature of the welding carriage is improperly set, smooth travel of the welding carriage about the track may be hindered or otherwise adversely affected. More particularly, the welding carriage may be subjected to undue vibration which may de-stabilize the welding carriage and may tend to cause the welding torch to deviate from its weld path resulting in poor weld quality at the welding joint.

Accordingly, it would be advantageous to have a welding carriage whose curvature adjustment could be performed with increased precision and with a tendency toward reducing reliance on approximation and trial and error. In this regard, it would be most advantageous to have a welding carriage that could be adjusted to conform precisely to a specific pipe diameter, and this, for a broad range of pipe diameters. Such a welding carriage would tend to generally increase efficiency in automated pipe welding operations as equipment set-up time could be effectively reduced. In addition, by providing the welding carriage with a more precise adjustment for curvature, the stability of the welding carriage may tend to be improved thereby contributing to the formation of strong, uniform welds.

If strong dependable welds are to be formed, the position of the welding torch relative to the welding joint must be accurately controlled during the welding operation. The welding torch must be moved accurately and uniformly along the weld path. Travel speed of the welding carriage about the track must also be regulated. Moreover, adequate stability must be afforded to the welding torch during travel about the track. To achieve these ends, welding carriages are typically provided with an arrangement of one or more drive wheels, and a number of support or idler wheel assemblies mounted to the end support plates of the welding carriage. The drive and idler wheel assemblies tend to engage surfaces or edges of the guide-band and constrain movement of the welding carriage along the track.

One known welding carriage has a pair of drive wheels mounted to one of the end plates with the axes of the drive wheels oriented parallel to the longitudinal axes of the pipe sections to be welded. The drive wheels are adapted to frictionally engage the outer face of the guide-band and to propel the welding carriage along the track. In addition, each end support plate of the welding carriage is provided with a first set of idler wheels for engaging opposed faces of the guide-band (that is, the inner and outer faces of the guide-band), and a second set of grooved idler wheels for engaging opposite edges of the guide-band. More specifically, for each end support plate the first set of idler wheels generally consists of a pair of outer idler wheels and a pair of inner idler wheels disposed on opposite sides of the end support plate.

Such a welding carriage tends to have a generally complex construction. As a result, it tends to be more prone to mechanical breakdown and tends to require more servicing and repair. Moreover, the number of idler wheels and their relative locations on the welding carriage tend to make installation and removal of the welding carriage from the guide-band awkward and difficult. In addition, this drive and idler wheel arrangement tends to be suitable only for use with certain guide-band structures, notably, guide-band structures that are of generally unitary construction. This arrangement tends to require that the outer face of the guide-band be free of obstacles that would otherwise interfere with the movement of any of the drive or idler wheels. Guide-band structure tends not to be uniform and often varies depending on the geometry of the pipe section to be welded. In some applications, particularly where the pipe section has a relatively small diameter, it may be impractical to employ a one-piece guide-band. In such cases, it may be more appropriate to use a hinged guide-band. A welding carriage provided with the foregoing arrangement would likely be unable of accommodating such a guide-band, as the hinging hardware would likely impede travel of the drive wheels. In other instances, other hardware such as the type used to place the guide-band in tension about the pipe section, may provide an obstacle for the drive wheels of this welding carriage.

Another welding carriage that is currently available uses a simplified four-wheel configuration. Therein, this welding carriage is provided with an arrangement of three idler wheels and a single drive wheel. One pair of idler wheels is provided on one of the end support plates to engage an edge of the guide-band. The remaining one idler wheel and drive wheel are similarly mounted on the other of the end support plates to engage the opposite edge of the guide-band. In sum, this wheel arrangement provides two points of engagement for each edge of the guide-band. In addition, the idler wheel pair is relatively staggered from the idler and drive wheel pair, such that the wheel arrangement is asymmetrical about the guide-band.

While this welding carriage tends to avoid some of the drawbacks associated with the previously described welding carriage, its versatility tends be limited by the configuration of its drive and idler wheels. The asymmetrical arrangement of the drive and idler wheels tends to limit the use of this welding carriage to relatively large pipe diameter welding applications. This is due, in part, to guide-band structure. In welding applications involving large pipe diameters, guide-bands typically have a splice with a gap formed between the guide-ban portions. The gap is typically bridged by a piece of banding material that is incorporated into the guide-band structure to lap the joint. While the welding carriage described above is generally capable of traversing the crossing of these lap joints, its ability to traverse un-lapped joints or otherwise compensate for minor guide-band imperfection tends to be rather limited. For instance, the welding carriage described above may not be appropriate for use in applications involving pipe sections of relatively small diameter where hinged guide-bands are used. This is because such guide-bands typically have an un-lapped gap between the guide-band sections. At the moment when the welding carriage crosses over the gap, a given wheel assembly of a pair will tend be directly over the gap and thus not in a position to make full contact with an edge of the guide-band. For that particular edge, there will only be a single effective point of engagement on the track, that is, the other wheel assembly of the pair. This tends to be insufficient to maintain adequate stability of the welding carriage. In particular, when the welding carriage encounters an un-lapped gap during its travel about the track, it may have a tendency to skip which could cause the welding torch to deviate from its predetermined weld path. In the result, weld quality at the welding joint could be adversely affected.

Accordingly, it would be desirable to provide a welding carriage with an arrangement of drive and idler wheels that would be capable of maintaining adequate stability while negotiating lapped or un-lapped joints on a guide-band. Such a welding carriage would be versatile and would tend to accommodate a variety of guide-band structures and generally, be suitable for use in welding applications involving a broad range of pipe diameters. In this regard, it would be most advantageous to configure the drive and idler wheels of such a welding carriage so as to have multiple points of engagement with the edges of the guide-band, and this at all times during carriage travel on the track.

### SUMMARY OF THE INVENTION

In an aspect of the invention, there is a carriage guided by a track associated with a workpiece. The carriage has a frame and a swing arm co-operable with the frame. The swing arm has a free end from the frame. The carriage also has an indexing assembly operable to fix the free end of the swing arm in a predetermined angular position selected from a set of discrete angular positions relative to the frame. When the free end of the swing arm is fixed in the predetermined angular position relative to the frame, the swing arm is operable to engage a first edge of the track.

In additional feature of the invention, the swing arm has an indexing aperture and the indexing assembly has a first indexing member. The first indexing member is co-operable with the indexing aperture to position the swing arm in the predetermined angular position.

In another additional feature of the invention, the frame has a first indexing aperture and the indexing assembly has a first indexing member. The first indexing member is co-operable with the first indexing aperture to position the swing arm in the predetermined angular position. In a further additional feature of the invention, the swing arm has a second indexing aperture. The second indexing member is co-operable with the second indexing aperture to position the free end of the swing arm in the predetermined angular position. In a further still additional feature of the invention, the indexing assembly has a second indexing member and an indexing disc. The indexing disc has a third indexing aperture and a fourth indexing aperture. The first indexing member is co-operable with the first and third indexing apertures and the second indexing member is co-operable with the second and fourth indexing apertures, to position the free end of the swing arm in the predetermined angular position.

In yet another additional feature of the invention, the carriage has a second swing arm co-operable with the frame. The second swing arm has a free end from the frame. The indexing assembly is operable to fix the free end of the second swing arm in a predetermined angular position selected from a second set of discrete angular positions relative to the frame. In a further additional feature of the invention, the carriage has a third swing arm and a fourth swing arm. The third and fourth swing arms are co-operable with the frame. Each of the third and fourth swing arms has a free end from the frame. The indexing assembly is operable to fix each of the free ends of the third and fourth swing arms in a predetermined angular position selected from a third set of discrete angular positions relative to the frame.

In yet another additional feature of the invention, the carriage further has a third swing arm and a fourth swing arm. The third and fourth swing arms are co-operable with the frame. Each of the third and fourth swing arms has a free end from the frame. The carriage also has a second indexing assembly that is being operable to fix each free end of the third and fourth swing arms in a predetermined angular position selected from a third set of discrete angular positions relative to the frame.

In still another additional feature of the invention, the carriage further has a second swing arm co-operable with the frame. The second swing arm has a free end from the frame. The carriage also has a second indexing assembly that is operable to fix the free end of the second swing arm in a second predetermined angular position selected from a second set of discrete angular positions relative to the frame. In a further additional feature of the invention, when fixed the predetermined angular position, the second swing arm is operable to engage a second edge of the track opposite to the first edge. In another additional feature of the invention, the swing arms are mounted to the frame at spaced-apart locations. When fixed in the second predetermined angular position, the second swing arm is operable to engage the first edge of the track. In yet another additional feature of the invention, the carriage further has a third and fourth swing arm. The third and fourth swings arms are co-operable with the frame. Each of the third and fourth swing arms has a free end from the frame. The carriage further has a third indexing assembly that is operable to fix the free end of the third swing arm in a third predetermined angular position selected from a third set of discrete angular positions relative to the frame and a fourth indexing assembly that is operable to fix the free end of the fourth swing arm in a fourth predetermined angular position selected from a fourth set of discrete angular positions relative to the frame. In a further additional feature of the invention, the swing arm and the second swing arm are mounted to the frame at first and second spaced-apart locations. The third and fourth swing arms are mounted to the frame at third and fourth spaced-apart locations. When fixed in the second predetermined angular position, the second swing arm is operable to engage the first edge of the track. When fixed in the third predetermined angular position, the third swing arm is operable to engage a second edge of the track opposite to the first edge. When fixed in the fourth predetermined angular position, the fourth swing arm is operable to engage the second edge of the track.

In another aspect of the invention, there is a carriage guided by a track associated with a workpiece. The carriage has a frame having a first indexing aperture; a swing arm co-operable with the frame, the swing arm having a second indexing aperture and a free end from the frame; an indexing disc having third and fourth indexing apertures; and first and second indexing members, the first indexing member being co-operable with the first and third indexing apertures and the second indexing member being co-operable with the second and fourth indexing apertures, to fix the free end of the swing arm in a predetermined angular position selected from a set of discrete angular positions relative to the frame. When the free end of the swing arm is fixed in the predetermined angular position relative to the frame, the swing arm is operable to engage a first edge of the track.

In yet another aspect of the invention, there is a carriage guided by a track associated with a workpiece. The carriage supports operable machinery. The carriage has a frame and first, second, third, fourth, fifth and sixth wheel assemblies. Each of the wheel assemblies are mounted to the frame. The first, second and third wheel assemblies are co-operable with a first edge of the track. The fourth, fifth, and sixth wheel assemblies are co-operable with a second edge of the track opposite the first edge. The second wheel assembly is arranged between the first and third wheel assemblies. The first and third wheel assemblies are spaced away from the second wheel assembly. The first wheel assembly is disposed opposite the fourth wheel assembly. The second wheel assembly is disposed opposite the fifth wheel assembly and the third wheel assembly is disposed opposite the sixth wheel assembly.

In additional feature of that aspect of the invention, the first and third wheel assemblies are evenly spaced away from the second wheel assembly. In yet another additional feature of that aspect of the invention, the first, second and third wheel assemblies are mounted to the frame at first, second and third, spaced-apart locations. In a further still additional feature of that aspect of the invention, the spacing between the first location and the second location is equal to the spacing between the second location and the third location.

In another additional feature of that aspect of the invention, the second and fifth wheel assemblies are positioned below the operable machinery providing a fixed distance between the operable machinery and the track.

In yet another additional feature of that aspect of the invention, the first and fourth wheel assemblies are positioned below the operable machinery providing a fixed distance between the operable machinery and the track.

In still another additional feature of that aspect of the invention, the third and sixth wheel assemblies are positioned below the operable machinery providing a fixed distance between the operable machinery and the track.

In a further still additional feature of that aspect of the invention, one of the wheel assemblies is a drive wheel assembly for urging the carriage along the track. In yet another additional feature of that aspect of the invention, the second wheel assembly is the drive wheel assembly.

### BRIEF DESCRIPTION OF THE DRAWINGS

For a better understanding of the present invention and to show more clearly how it may be carried into effect, reference will now be made to the exemplary embodiments illustrated in the accompanying drawings, which show the apparatus according to the present invention and in which:

FIG. 1 is a perspective view of a carriage according to an illustrative embodiment of the present invention, showing the carriage being supported on a track mounted about a pipe section, the carriage carrying an automated welding apparatus;

FIG. 2 is an end view of the carriage of FIG. 1 taken in the direction of arrow “2” with the welding apparatus removed;

FIG. 3 is another end view of the carriage of FIG. 1 taken opposite the view shown in FIG. 2 with the welding apparatus removed;

FIG. 4 is a side view of the carriage of FIG. 1;

FIG. 5 is a plan view of the carriage of FIG. 1 taken in the direction of arrow “5”;

FIG. 6 is another plan view of the carriage of FIG. 1 taken opposite the view shown in FIG. 5 showing six wheel assemblies of the carriage bearing against the edges of the guide-band which are shown in dashed lines;

FIG. 7 is a plan view similar to that shown in FIG. 6 showing three wheel assemblies spaced away from the edges of the guide-band (shown in dashed lines) to facilitate removal of the carriage from the track;

FIG. 8 is an exploded end view of the carriage similar to that shown in FIG. 2, with the pair of secondary handle members of the carriage removed;

FIG. 9 is an exploded end view of the carriage similar to that shown in FIG. 3, with the primary handle member of the carriage removed;

FIG. 10 is an exploded side view of the carriage of FIG. 1;

FIG. 11 is an exploded plan view of the carriage of FIG. 1 taken in the same direction as FIG. 5 with the platform of the support frame removed;

FIG. 12a is a cross-sectional view of a drive block of the carriage shown in FIG. 11;

FIG. 12b is a plan view of the drive block shown in FIG. 12a;

FIG. 13 is a cross-sectional view of a swing arm shown in FIG. 11 taken along the section ‘13-13’;

FIG. 14a is a partial, schematic cross-sectional view of the carriage of FIG. 2 showing a pair of swing arms adjusted to accommodate the curvature of a convexly curved, pipe section having a diameter of approximately 4 inches;

FIG. 14b is a partial, schematic cross-sectional view of the carriage of FIG. 2 showing a pair of swing arms adjusted to accommodate the curvature of a convexly curved, pipe section having a diameter of approximately 42 inches;

FIG. 14c is a partial, schematic cross-sectional view of the carriage of FIG. 2 showing a pair of swing arms adjusted to accommodate a flat metal section;

FIG. 14d is a partial, schematic cross-sectional view of the carriage of FIG. 2 showing a pair of swing arms adjusted to accommodate the curvature of a concavely curved, pipe section having a diameter of approximately 100 inches;

FIG. 15a is a partial, enlarged plan view of a spring-loaded clamping mechanism of the drive block illustrated in FIG. 3, showing the handle member of the clamping mechanism in a first position and the drive wheel spaced away from the edge of the guide-band;

FIG. 15b is a partial, enlarged plan view similar to that shown in FIG. 15a, showing the handle member in a second position and the drive wheel bearing against the edge of the guide-band;

FIG. 16a is a partial, enlarged plan view similar to that shown in FIG. 15a, showing the biasing mechanism engaged and urging three wheel assemblies against the edge of the guide-band;

FIG. 16b is a partial, enlarged plan view similar to that shown in FIG. 15a, showing the biasing mechanism partially disengaged;

FIG. 16c is a partial, enlarged plan view similar to that shown in FIG. 15a, showing the biasing mechanism fully disengaged; and

FIG. 17 is a partial, schematic cross-sectional view of the carriage of FIG. 2 showing the geometry of the support arm assemblies of the carriage.

### DETAILED DESCRIPTION OF AN ILLUSTRATIVE EMBODIMENT OF THE INVENTION

The description that follows, and the embodiments described therein, are provided by way of illustration of an example, or examples of particular embodiments of the principles of the present invention. These examples are provided for the purposes of explanation, and not of limitation, of those principles and of the invention. In the description that follows, like parts are marked throughout the specification and the drawings with the same respective reference numerals. The drawings are not necessarily to scale and in some instances proportions may have been exaggerated in order more clearly to depict certain features of the invention.

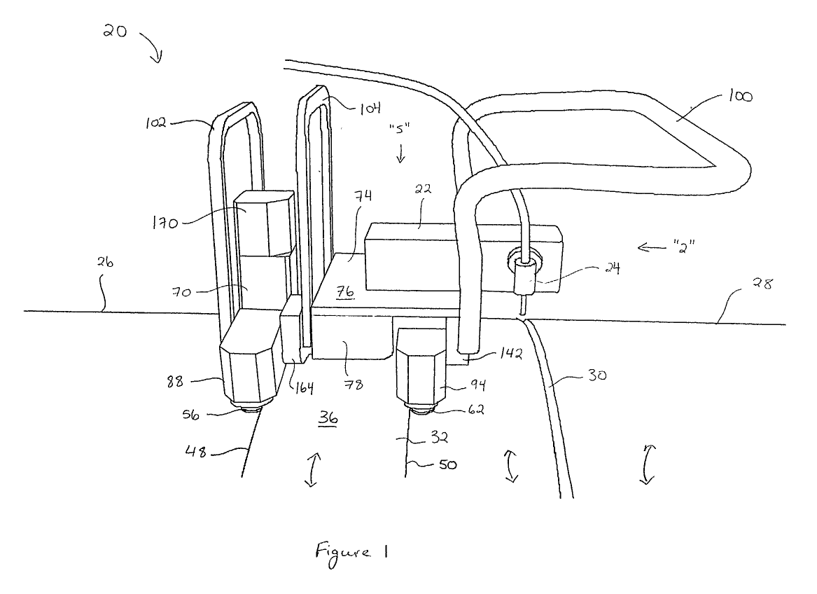

Referring to FIG. 1, in an illustrative embodiment, a carriage, generally indicated as 20, is provided to support an automated welding apparatus 22 equipped with a welding torch 24. The welding torch 24 is operable to weld end-to-end, two adjoining work pieces, in the nature of convexly curved, sections of pipe 26 and 28, along a generally bevelled weld groove or joint 30. Generally speaking, the carriage 20 is movable in a path parallel to the weld joint 30 and tends to provide a stable platform to effect movement of the welding torch 24 through a predetermined weld path around the pipe sections to be welded.

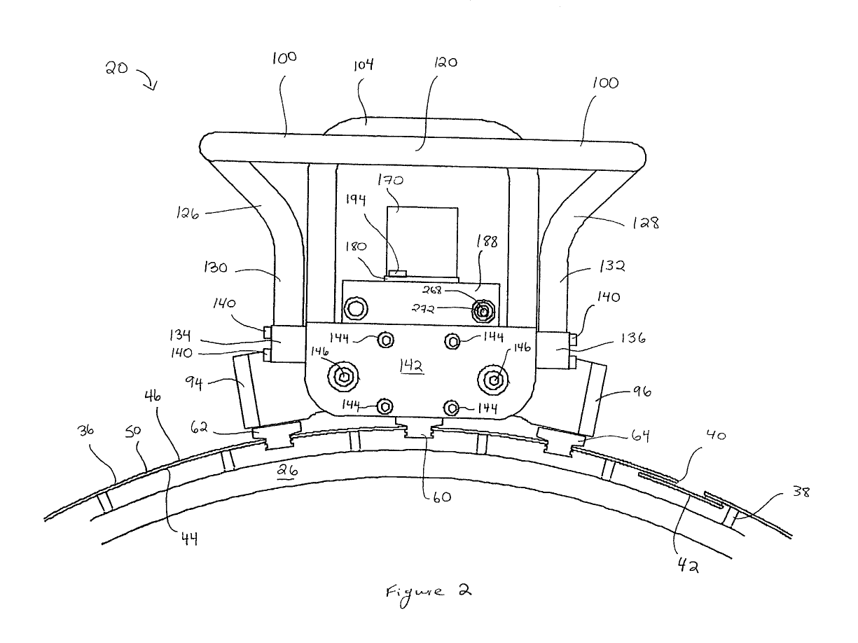

The carriage 20 is supported on, and adapted to travel along, a track 32 mounted concentrically about an end of one of the pipe sections, for instance, the pipe section 26, adjacent the weld joint 30. The track 32 consists generally of a flat, relatively thin, metal guide-band 36 that is fitted, and placed in tension, about the pipe section 26. Feet or stud members 38 (shown in FIG. 2) provided on the guide-band 36, allow the guide-band 36 to be radially spaced or offset from the outer face of the pipe section 26.

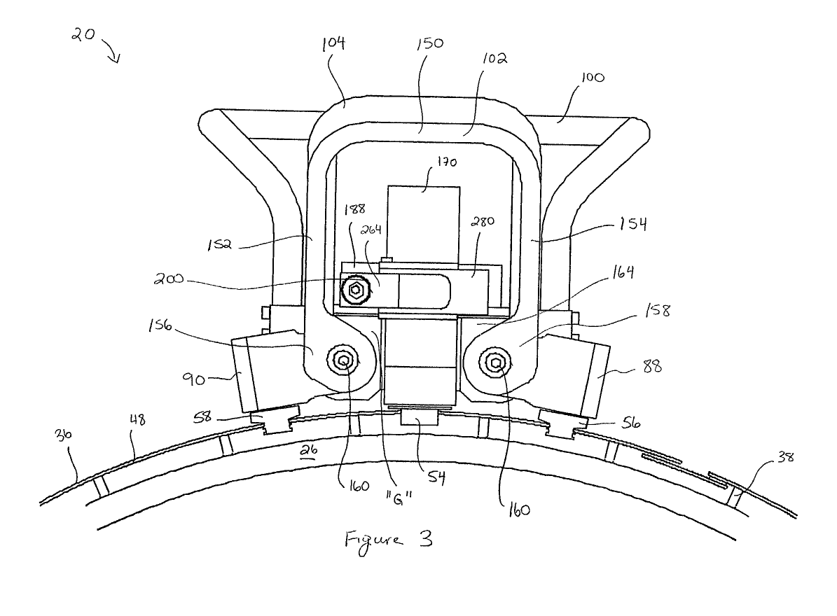

The guide-band 36 shown in FIGS. 1, 2 and 3 is illustrative of the type of guide-band used in welding applications involving large-diameter pipes. In the illustrative embodiment, the diameter of the pipe section 26 is 42 inches. The guide-band 36 has a thickness of 0.10 inches and a width of approximately five inches edge-to-edge. As shown in FIGS. 2 and 3, the guide-band 36 has at least one splice 40. The gap at the splice 40 is bridged by a piece of banding material 42 incorporated to the guide-band structure, thus forming a lapped joint. Depending on the particular welding application, other types of guide-bands may be used, for instance, continuous one-piece bands or hinged guide-bands. These guide-bands may have lapped or un-lapped joints.

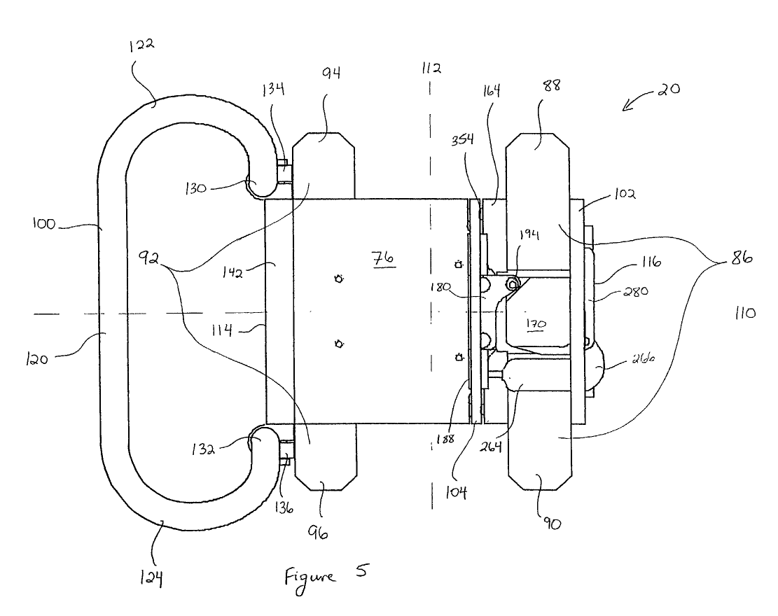

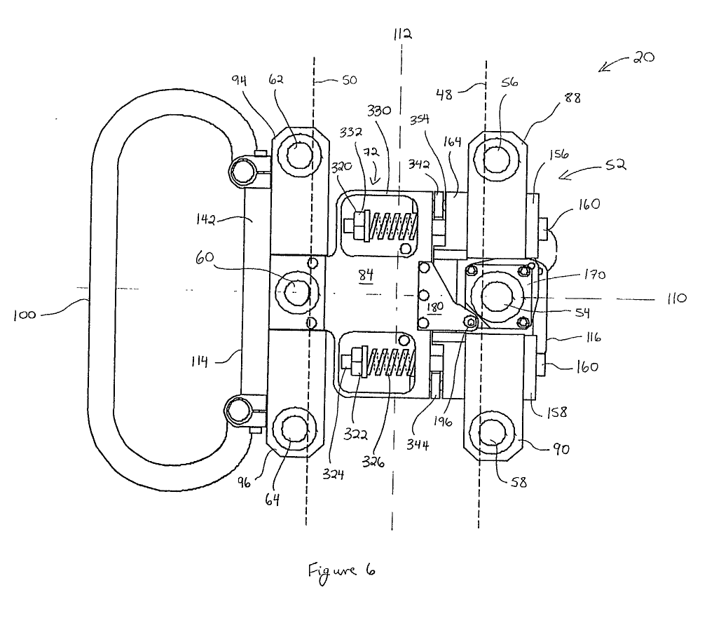

The guide-band 36 has an inner face 44 opposite the pipe section 26, an outer face 46, and opposed edges 48 and 50. When installed on the track 32, the carriage 20 will be mounted to travel over the outer face 46 of the guide-band 36 and will ride on the edges 48 and 50. An arrangement 52 of drive and support wheels (best shown in FIGS. 6 and 7) will engage the edges 48 and 50 to effect travel of the carriage 20 in a constrained orbit around the track 32. As will be described in greater detail below, the drive and support wheel arrangement 52 generally includes a drive wheel assembly 54 and a pair of support or idler wheel assemblies 56 and 58, all of which are provided to engage the edge 48 of the guide-band 36. The arrangement 52 also has a set of support or idler wheel assemblies 60, 62 and 64 disposed opposite to the assemblies 54, 56 and 58 to engage the opposite edge 50 of the guide-band 36.

During the welding operation, the carriage 20 will be driven along the track 32, in either of clockwise or counter-clockwise directions, by a motor 70 that is operatively connected to the drive wheel assembly 54. A spring-loaded mechanism 72 (shown in FIGS. 6 and 7) for biasing the idler wheel assemblies 56, 58, 60, 62 and 64 against the edges 48 and 50 of the guide-band 36, will tend to maintain the carriage 20 firmly engaged on the track 32. The travel speed of the carriage 20 will tend to be uniform and may be electronically controlled. As the carriage 20 advances along the guide-band 36, the welding torch 24 mounted on the carriage 20 will be moved along the weld joint 30 to effect continuous welding of the pipe sections 26 and 28. The welding torch 24 may use the GMAW (Gas Metal Arc Welding) or FCAW (Flux Core Arc Welding) process to perform the welding operation.

Referring to FIGS. 2, 3, and 4, the carriage 20 has a support frame 74 that generally includes a platform 76 for carrying the welding apparatus 22 and a base 78 which supports the platform 76. The platform 76 is secured to the base 78 by bolts 80 and 82 (shown in FIG. 10). The platform 76 is provided with fixtures (not shown) for mounting and securely retaining the welding apparatus 22 on the carriage 20. In a typical installation, the welding apparatus 22 is centrally mounted on the platform 76 with the welding torch 24 overhanging the platform 76 so as to lie in the plane of the weld joint 30, as shown in FIG. 1.

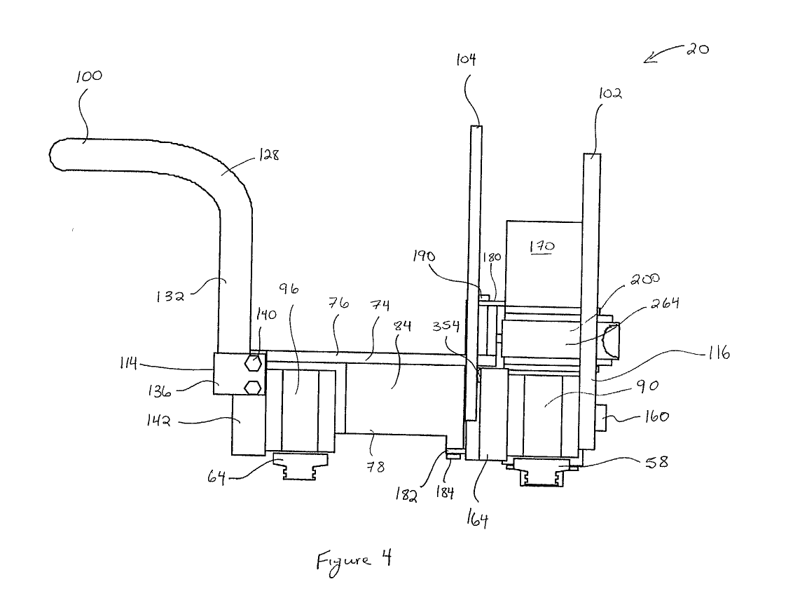

The base 78 has a generally, T-shaped body 84 (as shown in FIG. 11) which houses the idler wheel assembly 60 and the spring-loaded, idler wheel biasing mechanism 72. Connected to the support frame 74 at opposite ends of the base body 84 are a first pair 86 of support arm assemblies 88 and 90, and a second pair 92 of support arm assemblies 94 and 96 (as best shown in FIG. 5). The angular position of each support arm assembly 88, 90, 94, 96 relative to the plane of the platform 76 is adjustable to allow the carriage 20 to accommodate the curvature of the pipe section 26. Each support arm assembly 88, 90, 94, 96 houses one of the idler wheel assemblies 56, 58, 62, and 64, as the case may be.

To facilitate installation and removal of the carriage 20 from the track 32, the carriage 20 is also provided with a relatively large, primary handle member 100 and a pair of generally, U-shaped, secondary handle members 102 and 104. As will be explained in greater detail, the secondary handle members 102 and 104 are operable to disengage the idler wheel biasing mechanism 72 during installation or removal of the carriage 20 from the track 32.

For the purposes of general orientation, the carriage 20 can be said to have a longitudinal centerline 110, and a transverse centerline 112 that is perpendicular to the longitudinal centerline 110, as shown in FIG. 5. When the carriage 20 is mounted onto the track 32, the longitudinal centerline 110 is oriented generally, parallel to the longitudinal axis of the pipe section 26. Accordingly, the carriage 20 has a first longitudinal carriage end, known as a work end 114, and a second longitudinal carriage end 116. The work end 114 is so identified because it refers to the end of the carriage 20 which would be located adjacent the weld groove 30 when the carriage 20 is mounted onto the track 32. In a typical installation, the welding apparatus 22 would be mounted on the platform 76 about the longitudinal centerline with the welding torch 24 extending beyond the work end 114, as shown in FIG. 1. The second longitudinal carriage end 116 would be located opposite the work end 114, that is, away from the weld joint 30.

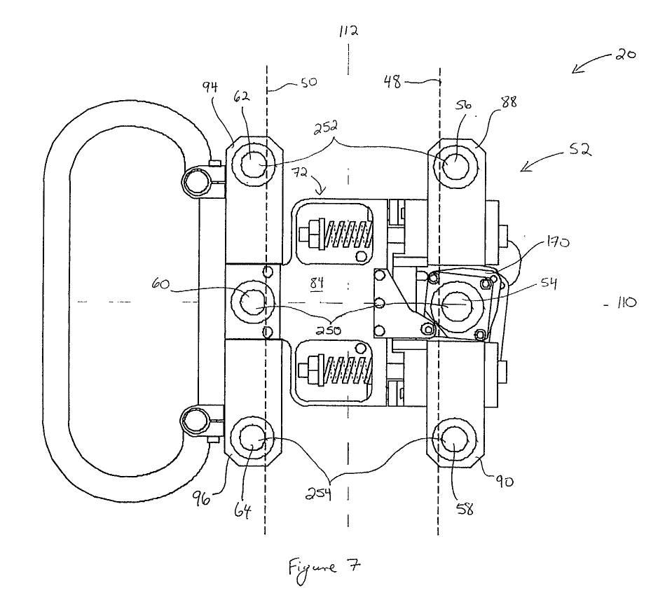

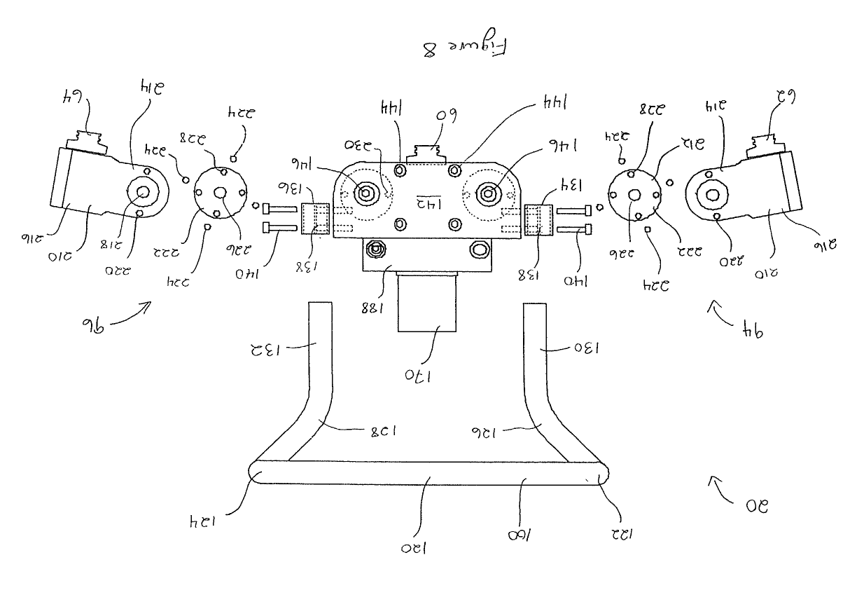

Referring to FIGS. 2 and 8, similar views of the carriage 20 are shown taken in the direction of the work end 114. The primary handle member 100 is generally formed from a tubular, metal section. The primary handle member 100 has a broad, medial handle portion 120 that is carried away from the work end 114 in a raised position relative to the platform 76 (as best shown in FIG. 4). The medial handle portion 120 is conveniently located to serve as a protective guard for the welding apparatus 22 mounted to the platform 76. However, the location of the medial handle portion 120 is not such that it hinders access to the platform 76. This tends to facilitate rapid installation or removal of the welding apparatus 22 from the carriage 20.

The medial handle portion 120 is joined to a pair of spaced apart, generally curved first shoulder portions 122 and 124. As best seen in FIG. 5, the shoulder portions 122 and 124 extend away from the medial handle portion 120 toward the second carriage end 116 to meet a second pair of shoulder portions 126 and 128. The shoulder portions 126 and 128 are bent inwardly relative to the medial portion 120 and are oriented to extend in the direction of platform 76. Each shoulder portion 126, 128 terminates in a relatively, straight mounting arm 130, 132 that connects to a clamping member 134, 136, as the case may be. The clamping members 134 and 136 are adapted to receive and securely retain the mounting arm 130 and 132 therewithin. Each clamping member 134, 136 has a pair of apertures 138 for receiving fasteners 140 therethrough. The fasteners 140 serve to tighten the clamping members 134 and 136 around the mounting arms 130 and 132, and to attach the clamping members 134 and 136 to an upstanding, end plate 142 connected to the support frame 74. The end plate 142 is fastened to the base 78 by a number of bolts 144 arranged in a generally, square configuration. A pair of tie-bolts 146 received through apertures 148 defined in the end plate 142, serve to pivotally mount the second pair 92 of support arm assemblies 94 and 96 to the end plate 142.

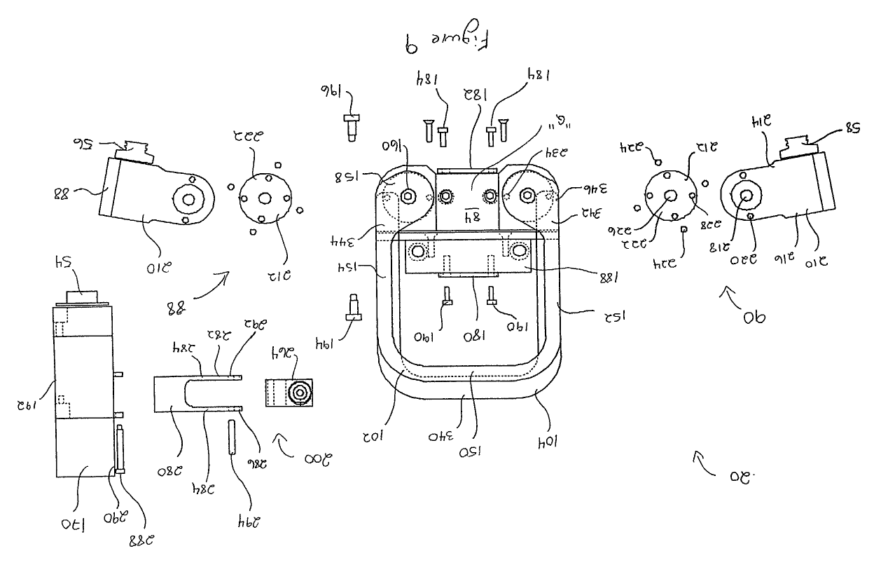

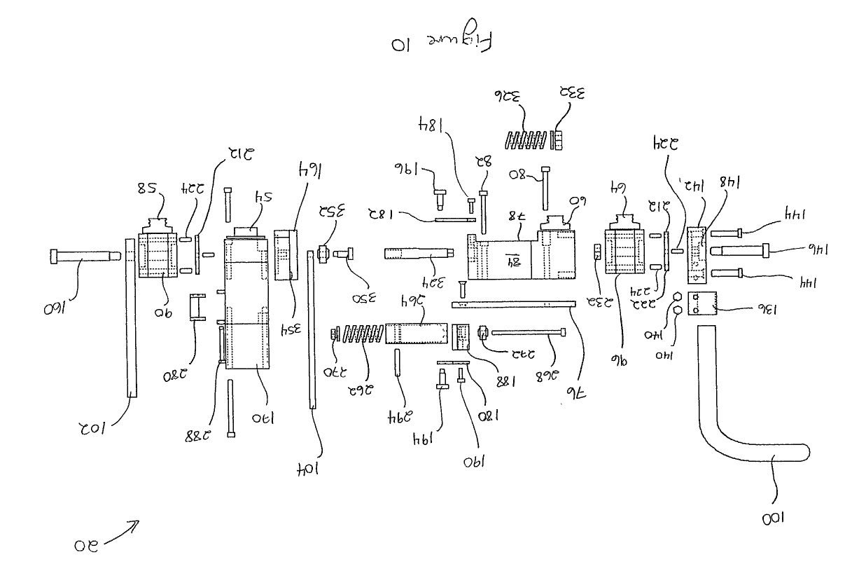

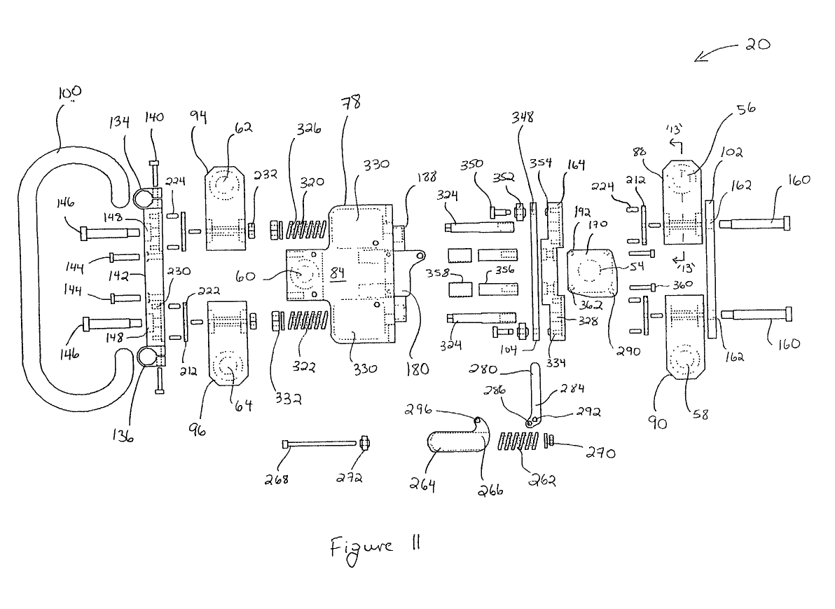

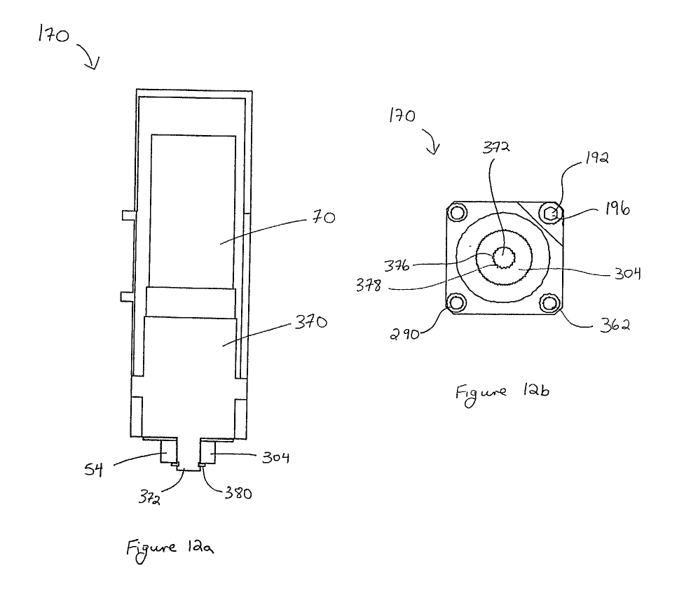

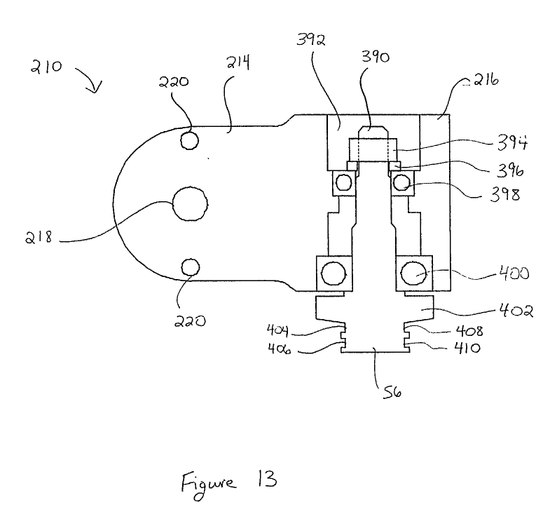

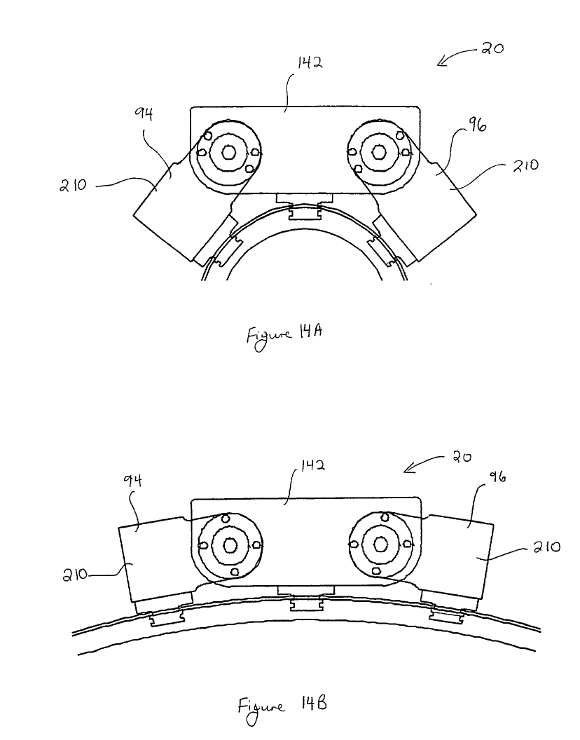

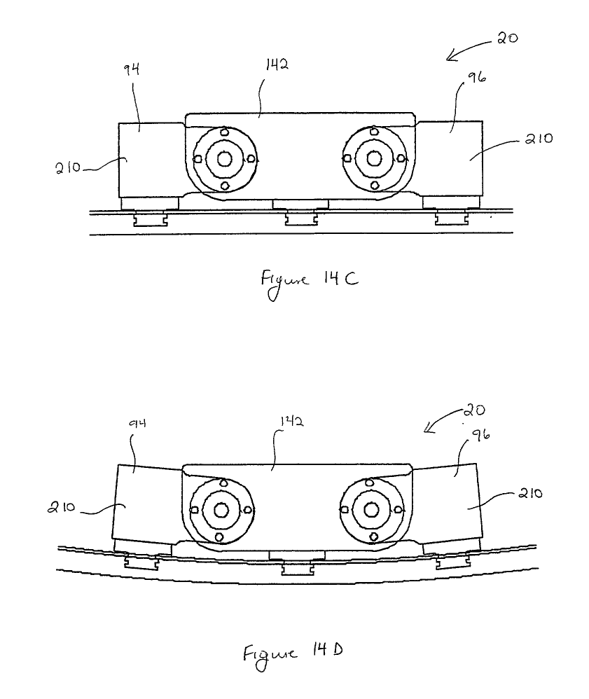

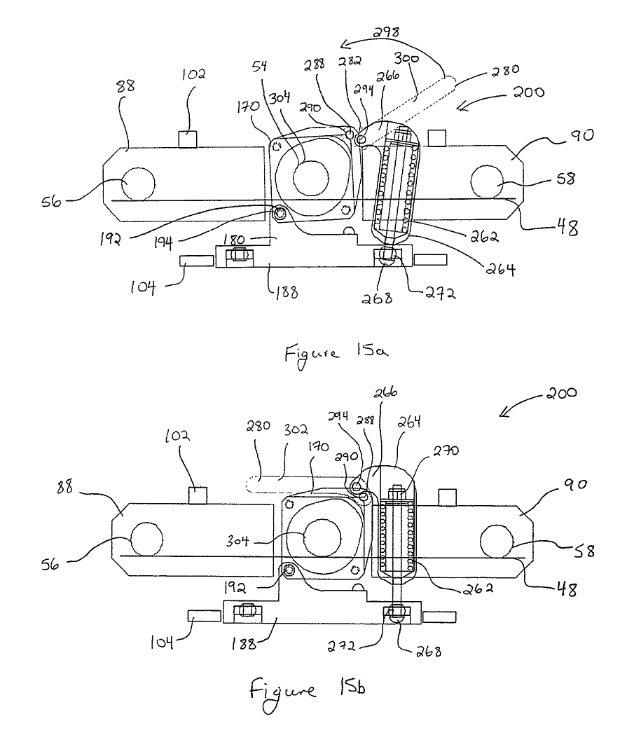

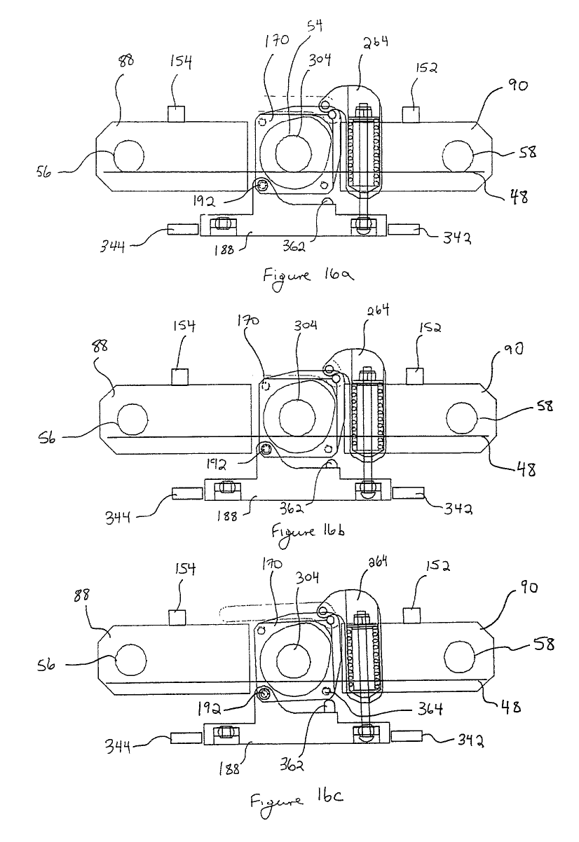

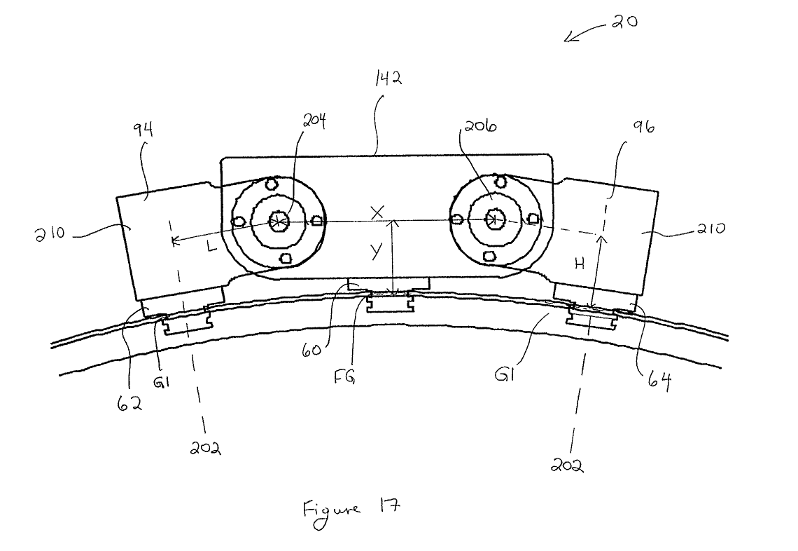

Referring to FIGS. 3 and 9, similar views of the carriage 20 are shown taken in the direction of the second longitudinal carriage end 116. The secondary handle member 102 includes a medial handle portion 150 and a pair of spaced-apart, arm portions 152 and 154 which depend from the medial portion 150. Each arm portion 152, 154 extends away from the medial portion 150 toward the platform 76 to terminate in an inwardly curved, lobe-shaped portion 156, 158, as the case may be. Tie-bolts 160 which are received within apertures 162 (shown in FIG. 11) defined in the lobe portions 156 and 158, attach the secondary handle member 102 to the first pair 86 of support arm assemblies 88 and 90, and tie the latter elements to a plate 164 of the support frame 74.

As shown in FIGS. 3 and 9, in this arrangement, the lobe portions 156 and 158 are spaced apart from each other such that a gap G is formed therebetween. Substantially nestled within the gap G is a generally, rectangular drive block 170 which houses the motor 70 and the drive wheel assembly 54. The drive block 170 is mounted between the secondary handle members 102 and 104, and pivotally connected to the support frame 74 by a pair of, spaced apart, generally L-shaped, plates 180 and 182. Connection of the plates 180 and 182 to the support frame 74 is shown in FIGS. 4, 9 and 10. Bolts 184 are used to attach the plate 182 to the base body 84. The plate 180 is fastened to an upstanding frame member 188 by a pair of bolts 190. The frame member 188 is, in turn, supported on, and bolted to, the platform 76 of the support frame 74.

Each plate 180, 182 is connected to a corner 192 of the drive block 170 by pivot pins 194 and 196. The drive block 170 is rotatable about an axis defined by the pivot pins 194 and 196. This rotation allows the drive wheel assembly 54 to be brought into, and out of, contact with the edge 48 of the guide-band 36 during set-up and removal of the carriage 20 on the track 32. As will be described in greater detail below, a spring-loaded clamping mechanism 200 connected to the drive block 170 is operable to urge the drive wheel assembly 54 into engagement with the edge 48 of the guide-band 36.

The configuration and structure of support arm assemblies 88, 90, 94 and 96 will now be described in greater detail with reference to FIGS. 5, 8, 9, 11 and 13. At the work end 114 of the carriage 20, the second pair 92 of support arm assemblies 94 and 96 are disposed symmetrically about the longitudinal centerline 110 of the carriage 20, such that the assembly 94 mirrors the assembly 96. Mounted between the assemblies 94 and 96, is the base body 84 which houses the idler wheel assembly 60. A similar arrangement is found at the second longitudinal carriage end 116, where the first pair 86 of support arm assemblies 88 and 90 are mounted symmetrically about the longitudinal centerline 110 with the drive block 170 mounted therebetween.

Further embodiments may incorporate pairs of support arm assemblies that are arranged parallel to a common edge of the guide-band 36. In this regard, it is possible to have, for instance, the assemblies 88 and 94, or the assemblies 90 and 96, integrally joined one to the other.

To assist in describing the relative geometry of the support arm assemblies, reference is made to FIG. 17 which shows a schematic, cross-sectional view of the support arm assemblies 94 and 96. For the purposes of establishing geometric reference points, each idler wheel assembly 62, 64 can be said to have a wheel axis identified as 202. Each support arm assembly 94, 96 has a swing arm 210 mounted to the end plate 142 about a pivot point 204 or 206, as the case may be. The pivot points 204 and 206 are coincident with the tie-bolts 146 used to attach the support arm assemblies 94 and 96 to the end plate 142. Accordingly, the effective length L of a given swing arm 210 can be defined as the distance between the pivot points 204 or 206, as the case may be, and the wheel axis 202, measured normal to the wheel axis 202. The effective height H of a given swing arm 210 can be defined as the distance between the center of the first groove G1 defined in the idler wheel assembly 62 or 64 and the pivot point 204 or 206, as the case may be.

In order for all three wheel assemblies 60, 62 and 64 to engage the edge 50 of the guide-band 36 throughout the range of operational diameters which can be accommodated by the carriage 20, it will be necessary to size the swing arms 210 appropriately. In this regard, certain dimensional relationships are provided in this embodiment. Herein, the effective length L of each swing arm 210 is equal to one half the distance X measured between the pivot points 204 and 206. For the sake of example only, if the distance X between the pivot points 204 and 206 is four inches, the effective length L of each swing arm 210 is 2 inches. The effective height H of each swing arm 210 is equal to the distance Y measured from the center of the first groove FG of the idler wheel assembly 60 to a plane defined by the pivot points 204 and 206. While the foregoing dimensional relationships have been described with reference to the swing arms 210 of support arm assemblies 94 and 96, they apply as well to the swing arms 210 of the assemblies 88 and 90. It will be appreciated that other dimensional relationships may also be provided e.g. having differing lengths of swing arms relative to distance X, as long as the wheel assemblies are still positioned to operably engage the edges of the guide-band and constrain the motion of the carriage 20 along the track 32.

The support arm assemblies 88, 90, 94 and 96 are structurally identical to each other such that a description of the support arm assembly 96 will suffice to describe the other support arm assemblies. The support arm assembly 96 includes the swing arm 210 and an indexing assembly 212 for precisely setting the angular position of the swing arm 210 relative to the plane of the platform 76. The swing arm 210 has a first, generally curved, proximal portion 214 for connecting to the support frame 74 and a second, generally rectangular, free or distal portion 216 which houses the idler wheel assembly 64. The first portion 214 has a central opening 218 and a pair of opposed, relatively smaller, apertures 220 which are radially spaced from the central opening 218.

Referring specifically to FIG. 1 , the indexing assembly 212 includes an indexing member, in the nature of a relatively, thin disc 222 and a set of locating members in the form of locking pegs or pins 224 for fixing the swing arm 210 in a specific, predetermined angular position relative to the plate 222 and to an element of the support frame 74. The disc 222 has a central opening 226 and four holes 228 which are adapted to receive the pins 224. The holes 228 are generally similar to the apertures 220 defined in the swing arm 210. The holes 228 are radially spaced from the central opening 226 and are disposed at specific locations about the disc 222. The particular arrangement of the holes 228 about the disc 222 corresponds to a specific, predetermined angular setting for the swing arm 210.

The disc 222 determines the set angle between the plane of the platform 76 and the swing arm 210. Accordingly, to adjust the carriage 20 as described to accommodate a particular pipe curvature, it is necessary to install a set of four identical indexing assemblies 212 (that is, four identical discs 222) within the support arm assemblies 88, 90, 94 and 96. Once the installation has been completed all four swing arms 210 will be set at the same angle relative to plane of the platform 76 and will be precisely locked in to a particular operational diameter. No further adjustment for curvature tends to be required.

Referring to FIGS. 8 and 11, a typical installation of the indexing assembly 212 in support arm assembly 96 is now described. The apertures 220 in the swing arm 210 are aligned with the corresponding holes 228 of the disc 222 and pins 224 are inserted through the aligned apertures. The swing arm 210 is thus fixed relative to the disc 222. In like fashion, the disc 222 is connected to the end plate 142, by aligning the remaining holes 228 on the disc 222 with a pair of apertures 230 defined in the end plate 142 and inserting pins 224 therethrough. When installed in this manner, the swing arm 210 is fixed in position relative to the end plate 142. Because of the specific configuration of holes 228 on the disc 222, the swing arm 210 is locked in a specific angular position relative to the plane of the platform 76. The various elements 142, 210 and 212 are held together by tie-bolt 146 which is fitted through the aligned apertures 148, 218 and 226 and by a nut 232 which is fastened to the end of the tie-bolt 146. The installation of the indexing assembly 212 in the support arm assembly 94 is achieved in the same manner.

Referring to FIGS. 9 and 11, there is shown a typical installation of the indexing assembly 212 in the support arm assembly 88. The installation of assembly 88 is generally similar to that described in relation to assembly 96. The swing arm 210 of assembly 88 is fixed relative to the disc 222 by aligning the swing arm apertures 220 with the corresponding holes 228 on the disc 222 and inserting the pins 224 therethrough. The swing arm 210 and the disc 222 are then mounted to the plate 164 of the support frame 74. The remaining holes 228 are aligned with a pair of apertures 234 defined in the plate 164 and pins 224 are inserted through the aligned apertures. The swing arm 210, the disc 222 and the plate 164 are tied together by the tie-bolt 160 which fits through the aligned apertures 218, 226 and 162. While the foregoing installation was described with reference to assembly 88, it applies equally to assembly 90.

In the field, where a different operational diameter is encountered, the angular setting of the swing arms 210 may be adjusted to the correct angle by replacing the set of four discs 222 in the support arm assemblies 88, 90, 94 and 96 with another set of four discs 222 specifically configured to the new operational diameter. In this way, adjustment for curvature is achieved through a parts interchange regime with each set of four discs 222 corresponding to a specific, predetermined angular position selected from a set of discrete angular positions relative to the platform 76.

With various sets of discs 222 on hand, the carriage 20 tends to be readily adaptable to a broad range of pipe sections. Notably, the carriage 20 can be used in applications which involve pipe sections that have relatively, small or large diameters, and that are convexly or concavely curved. In this regard, FIGS. 14a and 14b show the swing arms 210 adjusted to accommodate the curvature of convexly curved pipes having diameters of approximately, four inches and forty-two inches, respectively. Further, FIG. 14d shows the carriage 20 adapted to travel on a concavely curved, one-hundred-inch diameter pipe section. Thus adjusted, the carriage 20 may be used for internal pipe welding applications. As shown in FIG. 14c, the swing arms 210 may also be adjusted to allow the carriage to be used on a flat, metal section.

In the illustrative embodiment shown in FIGS. 8, 9 and 11, one indexing assembly 212 is used to set the angular position of each support arm assembly 88, 90, 94, 96. However, it will be appreciated that it may be possible to configure an indexing assembly for an embodiment, that would set the angle of one pair of swing arms 210 located parallel to a common edge of the guide-band, for instance, the swings arms 210 of assemblies 94 and 96 disposed at the work end 114. Further still, another embodiment may utilize a single indexing assembly for the swing arms 210 of opposed assemblies, for instance, assemblies 90 and 96, or assemblies 88 and 94. In such an embodiment, a carriage would only require two indexing assemblies. Moreover, in a further embodiment, a carriage could be provided with a single indexing assembly which may be capable of setting the angle of curvature for all four swing arms 210. It will be appreciated that other embodiments may utilize one, two or more indexing assemblies associated with one or more of the swing arms.

It will further be appreciated that other indexing assemblies may accomplish the same features of the described embodiments. Such other indexing assemblies include, but are not limited to, a series of set indexing holes on either of the swing arm or an element of the support frame 74 which align with a single indexing hole on the element of the support frame 74 or the swing arm, respectively; and an indexing pin to lock the swing arm in a fixed position as provided by the alignment of the hole on the support frame element and the opposing hole on the swing arm. In other embodiments an indexing member may be provided on either of the swing arm or an element of the frame for locating in one of a series of set indexing holes on the element of the frame or the swing arm, to lock the swing arm in a fixed predetermined position relative to the frame. Furthermore, it will be appreciated that in other embodiments other indexing assemblies may utilize other non-continuous, stepped mechanisms for locking the angular position of the swing arm in a predeteremined position relative to the frame.

Now, FIGS. 6 and 7 show the drive and idler wheel arrangement 52 in greater detail. The wheel assemblies 54, 56, 58, 60, 62 and 64 are symmetrically disposed about the transverse centerline 112 such that the wheel assemblies 54, 56 and 58 are mirror images of the wheel assemblies 60, 62 and 64. The wheel assemblies 54, 56, 58, 60, 62 and 64 are arranged in a first pair 250 of opposed wheel assemblies 54 and 60, a second pair 252 of opposed wheel assemblies 56 and 62, and a third pair 254 of opposed wheel assemblies 58 and 64. In any given pair, each wheel assembly is mounted directly opposite its counterpart wheel assembly. For instance, in the first pair 250, the wheel assembly 54 is mounted directly opposite its counterpart wheel assembly 60.

In this arrangement, the first wheel assembly pair 250 is mounted about the longitudinal centerline 110 with the second 252 and third 254 wheel assembly pairs being evenly spaced away from the first assembly pair 250. In a typical installation, the welding apparatus 22 carried on the platform 76 will be positioned above, and aligned with, the first wheel assembly pair 250. This arrangement allows the welding apparatus 22 to maintain a constant (radial) distance from the guide-band 36 throughout the entire curvature adjustment range of the carriage 20. The angular adjustment of the support arm assemblies 88, 90, 94 and 96 to accommodate the curvature of a particular pipe section, will not induce a change in the distance between the welding apparatus 22 and the guide-band 36. Since the radial distance remains unaffected by the carriage adjustment for curvature, there is no need to provide compensatory mechanisms to correct the radial distance for curvature variance. It will be appreciated that in other embodiments this result may be achieved by arranging the welding apparatus 22 above another pair of wheel assemblies, for instance, the second wheel assembly pair 252, or the third wheel assembly pair 254.

Arranged in the foregoing manner, the wheel assemblies 54, 56, 58, 60, 62 and 64 can be said to be generally symmetrical about both the longitudinal 110 and transverse 112 centerlines. The wheel assemblies are evenly distributed along the carriage 20 which tends to encourage stability of the carriage 20 on the track 32.

During most of the carriage's travel about the track 32, three wheel assemblies will generally, come to bear against each edge 48, 50 of the guide-band 36 to provide triangulated guide-band contact. The extent of guide-band engagement tends to favour the tightly constrained movement of the carriage 20 about the track 32 and tends to reduce vibration of the carriage 20. As a result, the carriage 20 tends to remain stable as it travels on the track 32 such that the welding torch 24 tends to be moved through its weld path with greater precision to form superior welds at the weld joint 30.

This type of guide-band engagement also tends to allow the carriage 20 to travel smoothly on guide-band structures which may have gaps between splices, un-lapped joints or minor imperfections. This is because, at any given point in time, at least two wheel assemblies will firmly engage each edge of the guide-band 36 to ensure that the carriage 20 maintains its course on the track 32. For instance, when the carriage 20 is crossing over an un-lapped joint, there may be a moment during which one of the wheel assemblies makes only partial contact with the edge of the guide-band 36 because that wheel assembly is directly over the un-lapped joint. During that moment, the carriage 20 will nonetheless tend to remain relatively stable on the track 32 because there are two other wheel assemblies which firmly engage each edge of the guide-band 36.

In this regard, the drive and support wheel arrangement 52 tends to be capable of generally accommodating gaps in the guide-band 36 that do not exceed 0.25 D; where D is the diameter of the drive wheel used in the drive wheel assembly 54. For instance, where a 0.75-inch diameter drive wheel is used, a gap in the guide-band measuring up to 0.188 inches is likely to be tolerated by the carriage 20. It will be appreciated that the dimensions of the drive wheel and the accommodating gaps may be altered and still encompass the embodiment.

In the illustrative embodiment, the drive and idler wheel arrangement 52 is provided with five idler wheel assemblies 56, 58, 60, 62 and 64, and a single drive wheel assembly 54 mounted between the two idler wheel assemblies 56 and 58. It will be appreciated that in other embodiments more than one drive wheel assembly may be provided to propel the carriage 20 on the track 32. For instance, it may be possible to have one drive wheel assembly for each edge 48 and 50 of the guide-band 36. In addition, in other embodiments it may be possible to vary the location of the drive wheel assembly relative to the other wheel assemblies such that the idler wheel assembly is not mounted between two idler wheel assemblies.

A description of the various mechanisms 200 and 72 used to urge the drive wheel assembly 54 and the idler wheel assemblies 56, 58, 60, 62 and 64, respectively against the edges 48 and 50 of the guide-band 36, is now provided. Referring to FIGS. 10, 11, 15a and 15b, the clamping mechanism 200 includes a spring 262 mounted within a housing 264. The spring housing 264 is generally elongated and terminates at one end with a curved member 266. The spring 262 is captively retained within the housing 264 by a bolt 268 and a nut and washer assembly 270. The bolt 268 is provided with a bearing mount 272 and serves to anchor the clamping mechanism 200 to the frame member 188. The bolt 268 is mounted through an aperture defined in the frame member 188, and extends into the spring housing 264 to be fitted through the spring 262. The nut and washer assembly 270 is fastened to the end of the bolt 268 thereby retaining the spring 262 within the housing 264.

The clamping mechanism 200 is also provided with a handle member 280 for actuating the clamping mechanism. The handle member 280 has a slightly curved end 282 which is formed by spaced-apart arms 284 (shown in FIG. 9). The arms 284 have apertures 286 which are adapted to receive a pivot pin 288 for pivotally connecting the handle member 280 to the drive block 170. The arms 284 are mounted to the drive block 170 at a corner 290 thereof positioned diagonally relative to the drive block corner 192. The curved end 282 of the handle member 280 also has apertures 292 that are located near to, and inwardly of, the apertures 286. The apertures 292 serve as connection sites to attach the handle member 280 to the spring housing 264. In particular, the handle member 280 is pivotally connected to the curved member 266 of the spring housing 264 by a pivot pin 294 fitted through apertures 292 and corresponding apertures 296 in the curved member 266.

Referring FIG. 15a and 15b, to actuate the clamping mechanism 200, the handle member 280 is rotated in a direction about arrow 298 from a first position 300 to a second position 302. FIG. 15a shows the handle member 280 in the first position 300. The handle member 280 is oriented away from the drive block 170 such that a relatively, obtuse angle is formed therebetween. The pivot pin 288 is spaced further away from the edge 48 of the guide-band 36, than the pivot pin 294. Accordingly, when the handle member 280 is in about first position 300, the handle member 280 is located away from the drive block 170. In this position, the drive block 170 is spaced away from the edge 48 of the guide-band 36 such that the drive wheel 304 of the drive wheel assembly 54 does not bear against the edge 48. For the purpose of illustration, the spacing between the drive wheel 304 and the edge 48 of the guide-band 36 has been exaggerated in FIG. 15a. In the illustrative embodiment, the drive wheel 304 is spaced approximately 0.030 inches away from the edge 48 of the guide-band 36. However, the spacing tends to vary depending on the diameter of the drive wheel used. Notably, when the handle member 280 is in the first position 300, the spring 262 within the spring housing 264 tends not to be in compression.

As the handle member 280 is moved from the first position 300 to the second position 302 in the direction of arrow 298, the curved member 266 rotates over the handle member 280 about pivot pin 288, again, about in the direction of arrow 298. Accordingly, this causes the drive wheel 304 to be urged toward the edge 48 of the guide-band 36, as the curved member 266 engages pivot pin 288. Notably, the movement of the spring housing 264 relative to the drive block 170 tends to compress the spring 262. When the handle member 280 is pivoted to the second position 302 as shown in FIG. 15b, the drive wheel 304 is urged to bear against the edge 48 of the guide-band 36 by the force of the spring 262. The pivot pin 288 is retained in position by the curved member 266.

The biasing mechanism 72 will now be described with reference to FIGS. 6 and 11. The biasing mechanism 72 has two identical assemblies 320 and 322 symmetrically disposed about the longitudinal centerline 110. For the purpose of explanation, the description of the assembly 320 will suffice for both assemblies. The assembly 320 includes a draw bolt 324 and a resilient member, in the nature of a spring 326. At one end, the draw bolt 324 is fastened to the tie-bolt 160 to secure the secondary handle member 102 and the support arm assembly 88 to the plate 164 of the mounting frame 74. The draw bolt 324 is fitted through an opening 328 defined within the plate 164, and mounted to extend into a cutout 330 formed within the base body 84. Mounted within the cutout 330 about the draw bolt 324, is the spring 326. A nut and washer assembly 332 is fastened to the opposite end of the draw bolt 324 so as to captively retain the spring 326 within the cutout 330. The spring 326 is held in compression within the cutout 330 so that a spring force acts against the nut washer assembly 332 and a surface of the base body 84. The spring force in each assembly 320 and 322 urges the idler wheel assemblies 56, 58, 60, 62 and 64 against the edges 48 and 50 (shown in FIG. 6 in dashed lines).

During removal of the carriage 20 from the guide-band 36, the biasing mechanism 72 may be disengaged to release the wheel assemblies 54, 56, 58, 60, 62 and 64 from the edges 48 and 50. As is explained in greater detail below, to disengage the biasing mechanism 72, the secondary handle members 102 and 104 are squeezed together to produce a lever action which causes the wheel assemblies 54, 56 and 58 to be displaced relative to the edge 48 of the guide-band 36. In this regard, the secondary handle member 104 functions like a lever to generate a prying force.

Referring to FIGS. 9, 10 and 11, the secondary handle member 104 has a medial handle portion 340 connected to a pair of spaced-apart, arm portions 342 and 344. The arm portions 342 and 344 extend away from the medial portion 340 toward the base 78. The end 346 of each arm portion 342, 344 has an aperture 348. Bolts 350 provided with bearing mounts 352, are inserted through the apertures 348 to tie the secondary handle member 104 to the base 78. Arranged in this way, the secondary handle member 104 is mounted between the base 78 and the plate 164. A pair of bumper pads 354 is provided on the plate 164 as a wear surface for the contact area between the plate 164 and the secondary handle member 104. The bumper pads 354 are mounted at locations spaced away from the ends 346 of the arm portions 342 and 344, as shown in FIG. 10. Notably, the bumper pads 354 serve as the fulcrum for the lever mechanism of the secondary handle 104.

In a typical procedure to remove the carriage 20 from the guide-band 36, the operator will grasp the primary handle member 100 with one hand and the secondary handle members 102 and 104 with the other. An inward force is applied to the medial portions 150 and 340 of the secondary handle members 102 and 104 to bring them together. The arm portions 344 and 346 will bear against, and pivot about, the bumper pads 354. The ends 346 of the arm portions 342 and 344 will be urged against the base 78 and will tend to cause the plate 164 to be moved away from the base 78 against the action of the springs 326 in the assemblies 320 and 322. The motion of the plate 164 relative to the base 78 will be linearly constrained by a pair of guide rods 356 mounted on bushings 358 which are press-fitted into the base body 84. The guide rods 356 are attached to the plate 164 by bolts 360. When the biasing member has been fully disengaged, the assemblies 54 56 and 58 will be moved out of engagement with the edge 48 of the guide-band 36, as shown in FIG. 7.

The disengagement of the biasing mechanism is thus effectively achieved with a one-handed movement. The operator can then manipulate the carriage 20 to effect its removal from the guide-band 36. In this manner, the removal procedure tends to be accomplished easily and swiftly. Notably, the operator is not required to shift or change the location of his or her hands on the carriage 20, since the disengagement or release mechanism is incorporated into the support structure of the carriage 20. In addition, the operator does not have to support any part of the carriage 20 during removal, other than at the handle grasping locations. This is particularly advantageous given the repetitive and frequent nature of the carriage removal operation.

FIGS. 16a, 16b and 16c show the various positions of the wheel assemblies 54, 56 and 58 prior to, and during, the disengagement procedure of the biasing mechanism 72. As shown in FIG. 16a, prior to the biasing mechanism 72 being disengaged, the drive wheel assembly 54 and the idler wheel assemblies 56 and 58 are urged to bear against the edge 48 of the guide-band 36. As the secondary handle members 102 and 104 are being squeezed together, the idler wheel assemblies 56 and 58 will be first to lose contact with the edge 48, as shown in FIG. 16b. For the purpose of illustration, the spacing between the idler wheel assemblies 56 and 58 and the edge 48 of the guide-band 36 has been exaggerated in FIG. 16b. The idler wheel assemblies 56 and 58 are spaced approximately 0.050 inches from the edge 48 of the guide-band 36. It will be appreciated that the other dimensions for spacing may be provided in other embodiments. At this point in the removal operation, the drive wheel assembly 54 remains engaged with the edge 48. When the secondary handle members 102 and 104 have been fully actuated, the drive wheel assembly 54 will also lose contact with the edge 48 despite the fact that the clamping mechanism 200 is in the second position 302. This occurs because, at this point, the plate 164 has been displaced a certain distance from the base 78 such that a bumper pad 362 mounted to the plate 164 opposite the drive block 170 (shown in FIGS. 7 and 16c), is urged against a corner 364 of the drive block 170. The force applied by the bumper pad 362 against the drive block corner 364 causes the drive block 170 to rotate about the pivotal axis coincident with the drive block corner 192. The rotation of the drive block 170 tends to cause the drive wheel assembly 54 to be pushed away from the edge 48.

The drive block 170 and the drive wheel assembly 54 will now be described in greater detail with reference to FIGS. 12a and 12b. The drive block 170 includes a gearbox 370 which is operatively connected to the motor 70 in the customary manner to transmit a driving force from the motor 70 to the drive wheel assembly 54. The gearbox 370 is of conventional construction. It has gears (not shown) configured to have a desired gear ratio and an output shaft 372 adapted for connection to the generally, annular drive wheel 304 of the drive wheel assembly 54. The output shaft 372 extends from the gearbox 370 and fits through an opening of the drive wheel 304. Splines 376 provided on the output shaft 372 mate with corresponding grooves 378 defined about the opening of the drive wheel 304. The drive wheel 304 is securely held in place on the output shaft 372 by a ring member 380 mounted about a distal end of the output shaft 372.

The drive wheel 304 is a serrated wheel typically made of a durable, wear-resistant substance, such as, carbide. Traction of the drive wheel 304 on the edge 48 of the guide-band 36 urges the carriage 20 to advance on the track 32 when the motor 70 is activated. In the illustrative embodiment, the diameter of the drive wheel 304 is 0.75 inches. However, a drive wheel of varying diameter may be used in cases where it is necessary to have the drive wheel adapted to a specific gear ratio in the gearbox 370 to ensure the carriage 20 attains a desired travel speed. In this regard, it is possible, for instance, to use a drive wheel that has a diameter of 0.875 inches.

FIG. 13 shows the idler wheel assembly 56 housed within the second distal portion 216 of the swing arm 210. The idler wheel assembly 56 is generally representative of the idler wheel assemblies 58, 62 and 64 such that a description of the idler wheel assembly 56 will suffice to describe the other wheel assemblies. This applies as well to the idler wheel assembly 60 housed within the base body 84, with the necessary modifications being made to the description to account for the idler wheel assembly 60 being mounting to the base body 84 instead of to the swing arm 210.

The idler wheel assembly 56 includes an elongated, shaft 390 rotatably mounted within an opening 392 defined within the second distal portion 216 of the swing arm 210. The shaft 390 is captively retained within the opening 392 at one end by a lock-nut 394 supported on a washer 396. Mounted about the opening 392 at two spaced-apart locations, is a pair of differently sized, first 398 and second 400 bearings which permit rotation of the shaft 390 relative to the swing arm 210.

The shaft 390 is typically made of a wear-resistant substance, such as, heat-treated steel. The section of the shaft 390 is not uniform throughout its length. As the shaft 390 extends away from the end secured by the lock-nut 394, the section of the shaft 390 increases. Further still, when the shaft 390 extends beyond the opening 392 it has a broad step 402 formed therein which extends radially outward from the shaft 390. Beyond the radial step 402, the section of the shaft 390 narrows and a pair of first 404 and second 406 radial grooves are formed within the shaft 390. Each groove 404, 406 has a contact surface 408, 410, respectively, for engaging an edge of the guide-band 36. At each contact surface 408, 410, the diameter of the shaft 390 is typically 0.75 inches. In the illustrative embodiment, the grooves 404 and 406 are 0.115 inches wide and are specifically sized to accommodate the 0.10-inch thickness of the guide-band 36. It will be appreciated that the dimensions of the grooves 404 and 406 may be altered and still encompass the embodiment. In the event, that a thicker guide-band is used, a part interchange matching band thickness to groove width on the shaft 390, would ensure that the idler wheel assembly was of a size to accommodate the thicker band. In addition, the width of the grooves 404 and 406 may also be increased in the case where the carriage 20 is adapted to travel on a pipe section having a relatively tight radius of curvature.

When the carriage 20 is installed on the track 32, care is taken to position the idler wheel assembly 56 such that the edge of the guide-band 36 is received within the first groove 404 so as to engage the first contact surface 408. In this regard, the relatively, wide step 402 tends to discourage the idler wheel assembly 56 from being improperly positioned relative to the edge of the guide band 36. During most of the carriage's travel about the track 32, the edge of the guide-band 36 will continuously engage the first contact surface 408. The second contact surface 410 will only engage the edge of the guide-band 36 when the carriage 20 rides over a lapped joint. This is because at the location of a splice, such as splice 40, the banding material 42 used to lap the joint is slightly offset from rest of the band such that it will generally be aligned with the second groove 406. The banding material 42 will tend to be smoothly received within the second groove 406 so as to engage the second contact surface 410. In this way, the carriage is encouraged to remain stable at all points on the guide-band 36.

Although the illustrative embodiment has been described in the context of a welding application, that is, the carriage 20 providing a movable platform for a welding apparatus 22, it will be appreciated that other equipment may be mounted onto the carriage 20. In this regard, the carriage 20 may be used to transport weld inspection equipment, such as sensors for assessing weld quality, about the track 32. However, use of the carriage 20 may not be limited solely to welding-related applications. The carriage 20 may also serve in other non-welding applications which require equipment or other such payload to be moved about a track in a stable manner.

An illustrative embodiment has been described in detail and a number of alternatives have been considered. As changes in or additions to the above described embodiments may be made without departing from the nature, or scope of the invention, the invention is not to be limited by or to those details, but only by the appended claims.

We claim:

1. A carriage guided by a track associated with a workpiece, the carriage comprising:
a frame;
a swing arm co-operable with said frame, said swing arm having a free end from said frame;
an indexing assembly operable to fix said free end of said swing arm in a predetermined angular position selected from a set of discrete angular positions relative to said frame;
wherein when said free end of said swing arm is fixed in said predetermined angular position relative to said frame, said swing arm is operable to engage a first edge of said track.

2. A carriage according to claim 1 wherein:
said swing arm has an indexing aperture; and
said indexing assembly has a first indexing member,
said first indexing member being co-operable with said indexing aperture to position said swing arm in said predetermined angular position.

3. A carriage according to claim 1 wherein:
said frame has a first indexing aperture; and
said indexing assembly has a first indexing member,
said first indexing member being co-operable with said first indexing aperture to position said swing arm in said predetermined angular position.

4. A carriage according to claim 3 wherein:
said swing arm has a second indexing aperture;
said first indexing member being co-operable with said second indexing aperture to position said free end of said swing arm in said predetermined angular position.

5. A carriage according to claim 4 wherein:
said indexing assembly has a second indexing member and an indexing disc, said indexing disc having a third indexing aperture and a fourth indexing aperture;
said first indexing member being co-operable with said first and third indexing apertures, and said second indexing member being co-operable with said second and fourth indexing apertures, to position said free end of said swing arm in said predetermined angular position.

6. A carriage according to claim 1 wherein:
said carriage has a second swing arm co-operable with said frame, said second swing arm having a free end from said frame; and
said indexing assembly is operable to fix said free end of said second swing arm in a predetermined angular position selected from a second set of discrete angular positions relative to said frame.

7. A carriage according to claim 6 wherein:
said carriage has a third swing arm and a fourth swing arm, said third and fourth swing arms being co-operable with said frame, each of said third and fourth swing arms having a free end from said frame; and
said indexing assembly is operable to fix each of said free ends of said third and fourth swing arms in a predetermined angular position selected from a third set of discrete angular positions relative to said frame.

8. A carriage according to claim 6 further comprising:
a third swing arm and a fourth swing arm, said third and fourth swing arms being co-operable with said frame, each of said third and fourth swing arms having a free end from said frame; and
a second indexing assembly being operable to fix each free end of said third and fourth swing arms in a predetermined angular position selected from a third set of discrete angular positions relative to said frame.

9. A carriage according to claim 1 further comprising:
a second swing arm co-operable with said frame, said second swing arm having a free end from said frame; and
a second indexing assembly being operable to fix said free end of said second swing arm in a second predetermined angular position selected from a second set of discrete angular positions relative to said frame.

10. A carriage according to claim 9 wherein when fixed in said second predetermined angular position, said second swing arm is operable to engage a second edge of said track opposite to said first edge.

11. A carriage according to claim 9 wherein:
said swing arms are mounted to said frame at spaced-apart locations, and
when fixed in said second predetermined angular position, said second swing arm is operable to engage said first edge of said track.

12. A carriage according to claim 9 further comprising:
third and fourth swing arms, said third and fourth swings arms being co-operable with said frame, each of said third and fourth swing arms having a free end from said frame;
a third indexing assembly being operable to fix said free end of said third swing arm in a third predetermined angular position selected from a third set of discrete angular positions relative to said frame; and
a fourth indexing assembly being operable to fix said free end of said fourth swing arm in a fourth predetermined angular position selected from a fourth set of discrete angular positions relative to said frame.

13. A carriage according to claim 12 wherein:
said swing arm and said second swing arm are mounted to the frame at first and second spaced-apart locations; and
said third and fourth swing arms are mounted to the frame at third and fourth spaced-apart locations,
when fixed in said second predetermined angular position, said second swing arm is operable to engage said first edge of said track,
when fixed in said third predetermined angular position, said third swing arm is operable to engage a second edge of said track opposite to said first edge, and
when fixed in said fourth predetermined angular position, said fourth swing arm is operable to engage said second edge of said track.

14. A carriage guided by a track associated with a workpiece, the carriage comprising:
a frame having a first indexing aperture;
a swing arm co-operable with said frame, said swing arm having a second indexing aperture and a free end from said frame;
an indexing disc having third and fourth indexing apertures; and
first and second indexing members, said first indexing member being co-operable with said first and third indexing apertures and said second indexing member being co-operable with said second and fourth indexing apertures, to fix said free end of said swing arm in a predetermined angular position selected from a set of discrete angular positions relative to said frame,
wherein when said free end of said swing arm is fixed in said predetermined angular position relative to said frame, said swing arm is operable to engage a first edge of said track.

15. A carriage guided by a track associated with a workpiece, the carriage supporting operable machinery, the carriage comprising:
a frame;
first, second, third, fourth, fifth and sixth wheel assemblies, each of said wheel assemblies being mounted to said frame;
said first, second and third wheel assemblies being co-operable with a first edge of the track;
said fourth, fifth, and sixth wheel assemblies being co-operable with a second edge of the track opposite the first edge;
said second wheel assembly being arranged between said first and third wheel assemblies;
said first and third wheel assemblies being spaced away from said second wheel assembly;
said first wheel assembly being disposed opposite said fourth wheel assembly;
said second wheel assembly being disposed opposite said fifth wheel assembly; and
said third wheel assembly being disposed opposite said sixth wheel assembly.

16. A carriage according to claim 15 wherein said first and third wheel assemblies are evenly spaced away from said second wheel assembly.

17. A carriage according to claim 15 wherein said first, second and third wheel assemblies are mounted to said frame at first, second and third spaced apart locations.

18. A carriage according to 17 wherein the spacing between said first location and said second location is equal to the spacing between said second location and said third location.

19. A carriage according to claim 15 wherein said second and fifth wheel assemblies are positioned below said operable machinery providing a fixed distance between said operable machine and said track.

20. A carriage according to claim 15 wherein said first and fourth wheel assemblies are positioned below said operable machinery providing a fixed distance between said operable machine and said track.

21. A carriage according to claim 15 wherein said third and sixth wheel assemblies are positioned below said operable machinery providing a fixed distance between said operable machine and said track.

22. A carriage according to claim 15 wherein one of said wheel assemblies is a drive wheel assembly for urging the carriage along the track.

23. A carriage according to claim 22 wherein said second wheel assembly is said drive wheel assembly.

24. A carriage according to claim 15 wherein:
said carriage has a longitudinal centreline and a transversal centerline perpendicular to said longitudinal centerline;
said first and third wheel assemblies are carried away from said longitudinal centerline; and
said fourth and sixth wheel assemblies are carried away from said longitudinal centerline opposite said first and third assemblies.

25. A carriage according to claim 24 wherein:
said first and third wheel assemblies are equally spaced away from said longitudinal centerline; and
said fourth and sixth wheel assemblies are equally spaced away from said longitudinal centerline.

26. A carriage according to claim 25 wherein said second and fifth wheel are located along said longitudinal centerline.

27. A carriage according to claim 24 wherein
said first, second and third wheel assemblies are carried away from said transversal centerline; and
said fourth, fifth and sixth wheel assemblies are carried away from said transversal centerline opposite said first, second and third wheel assemblies.

28. A carriage according to claim 27 wherein:
said first and fourth wheel assemblies are equally spaced from said transversal centerline, and
said third and sixth wheel assemblies are equally spaced from said transversal centerline.

29. A carriage guided by a track associated with a workpiece, the carriage comprising:
a frame;
first, second, third and fourth swing arms connected to said frame, each of said swing arms having a free end from said frame, each of said free ends having a wheel assembly, said free ends of said first and second swing arms being associated with a first edge of said track, said free ends of said third and fourth swing arms being associated with a second edge of said track opposite to said first edge,
an indexing assembly operable to fix each of said free ends in a predetermined angular position selected from a set of discrete angular positions relative to said frame;
wherein:
when said free ends of said first and second swing arms are fixed in said predetermined angular position relative to said frame, said wheel assemblies thereof are operable to engage said first edge of said track, and
when said free ends of said third and fourth swing arms are fixed in said predetermined angular position relative to said frame, said wheel assemblies thereof are operable to engage said second edge of said track.

30. A carriage according to claim 29 wherein:
said carriage has a longitudinal centerline and a transversal centerline perpendicular to said longitudinal centerline;
said free ends of said first and second swing arms are carried away from said longitudinal centerline; and
said free ends of said third and fourth swing arms are carried away from said longitudinal centerline opposite said free ends of said first and second swing arms.

31. A carriage according to claim 30 wherein:
said free ends of said first and third swing arms are equally spaced from said longitudinal centerline, and
said free ends of said second and fourth swing arms are equally spaced from said longitudinal centerline.

32. A carriage according to claim 29 wherein
